(19) United States
(12) Patent Application Publication
(10) Pub. No.: US 2008/0115134 A1
(43) Pub. Date: May 15, 2008

(54) REPAIR OF SYSTEM DEFECTS WITH REDUCED APPLICATION DOWNTIME

(76) Inventors: Ian A. Elliott, Fort Collins, CO (US); Benjamin D. Osecky, Fort Collins, CO (US); Gopalakrishnan Janakiraman, Palo Alto, CA (US); John R. Diamant, Fort Collins, CO (US); Arthur L. Sabsevitz, Monroe Township, NJ (US); Keith R. Buck, Fort Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/469,246

(22) Filed: Aug. 31, 2006

(51) Int. Cl. G06F 9/46

(52) U.S. Cl. 718/101

(57) ABSTRACT

A system comprising a first subsystem adapted to provide a service by executing a first code stored on the first subsystem. The system further comprises a second subsystem, communicably coupled to the first subsystem, on which a second code associated with the first code is stored. The second subsystem produces modified code by applying status files associated with the first code to the second code. The second subsystem provides the service in lieu of the first subsystem by executing the modified code.

### BACKGROUND

Most computer systems store operating system (OS) software (e.g., WINDOWS®, UNIX®). Each time the system is booted, the OS is launched and executed. Execution of the OS provides an environment within which various applications may be executed. For example, a server operated by a stock broker may use the UNIX® OS as an environment within which various database applications are executed. These database applications may be used, for instance, to provide stock-trading capability to customers via the broker's website.

It is possible that the OS has one or more defects (“bugs”). Often, when a defect is found, the manufacturer of the OS may release an OS “patch” which may be used to repair the defect. Unfortunately, applying a patch to an OS sometimes requires the system to be re-booted. Likewise, other system management tasks, such as OS recovery, also may require the system to be re-booted. Re-booting the system to patch/recover an OS (or to modify any other system component) can cause partial loss of the state (e.g., run-time application settings, current tasks) and complete loss of the availability of an application running on the system, thereby undesirably increasing application downtime. Increased downtime of financially sensitive (erg, stock trading) applications can result in substantial financial losses.

### BRIEF DESCRIPTION OF THE DRAWINGS

For a detailed description of exemplary embodiments of the invention, reference will now be made to the accompanying drawings in which:

FIG. 1 shows a system operating in accordance with embodiments of the invention;

FIG. 2 shows a flow diagram of a method in accordance with embodiments of the invention;

FIG. 3 shows a detailed flow diagram associated with the method of FIG. 2, in accordance with embodiments of the invention; and

FIG. 4 shows another detailed flow diagram associated with the method of FIG. 2, in accordance with embodiments of the invention.

### NOTATION AND NOMENCLATURE

Certain terms are used throughout the following description and claims to refer to particular system components. As one skilled in the art will appreciate, companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean either an indirect, direct, optical or wireless electrical connection, etc. Thus, if a first device couples to a second device, that connection may be through a direct electrical connection, through an indirect electrical connection via other devices and connections, through an optical electrical connection, through a wireless electromagnetic connection, etc. Further, a “state” of an application comprises a complete or nearly complete set of properties associated with the application.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

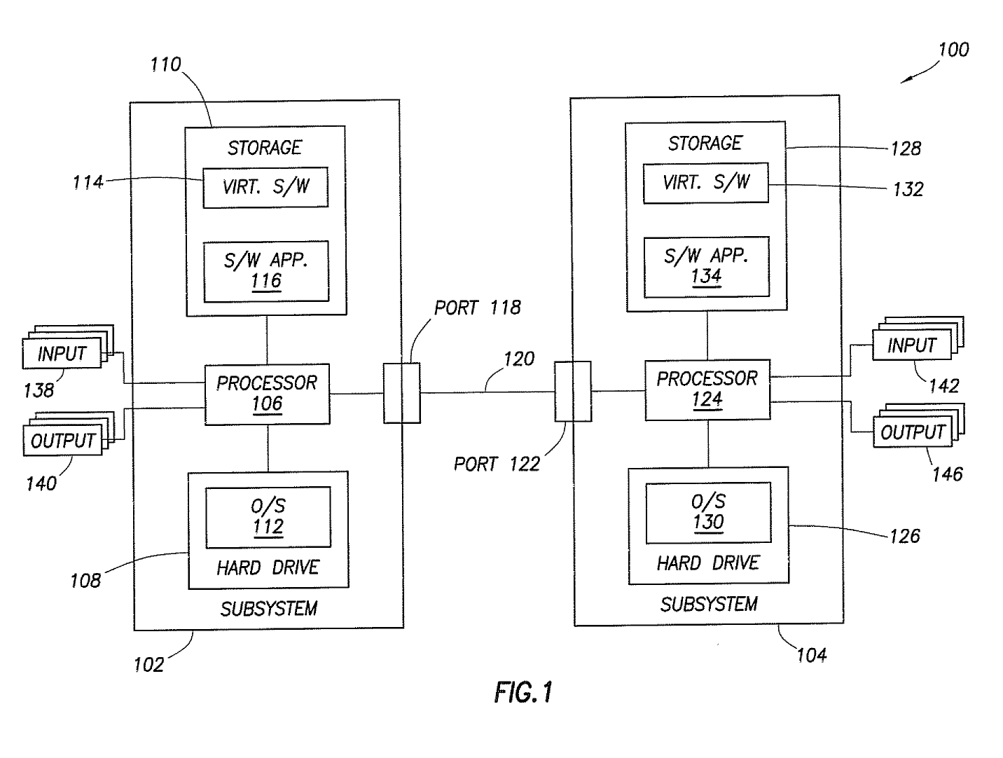

Described herein is a technique by which repairs or updates, such as OS patching, recovery and upgrading/updating operations, application updating/patching operations, and virtualization framework updating/patching operations, may be made to an electronic device without losing the state(s) of one or more applications being executed on the device and with minimal or no application downtime. FIG. 1 shows a system 100 comprising subsystems 102 and 104. The subsystems 102 and 104 may comprise any of a variety of systems, including personal computers (e.g., desktops, laptops), servers, personal digital assistants (e.g., BLACKBERRY® devices), etc. The subsystems 102 and 104 may comprise the same type of system or, in some embodiments, may comprise different types of systems. For instance, in some embodiments, the subsystems 102 and 104 may both comprise servers. In other embodiments, one of the subsystems may comprise a server while the other subsystem comprises a personal computer.

The subsystem 102 comprises a processor 106 coupled to a hard drive 108 and a storage (e.g., random access memory (RAM)) 110. The hard drive 108 may comprise an OS 112 (e.g., WINDOWS®, LINUX®, HP-UX®, UNIX®). Although only a single OS 112 is shown in the Figure, the scope of disclosure is not limited to any specific number of OSes. The processor 106 may couple to one or more input devices 138 (e.g., keyboard, mouse, optical device, network, microphone) and one or more output devices 140 (e.g., display, virtualized display, network printer). The storage 110 may comprise virtualization software 114 and a software application 116. The software application 116 may comprise any suitable type of software, including word processing software, spreadsheet software, database software, Internet-related software, server management software, online banking software, online stock-trading software, etc.

Virtualization software can be used to simulate one or more hardware computer components which may not physically exist. For example, a computer containing virtualization software may use the software to simulate (or “virtualize”) a network connection, a storage unit, or other such component which is not actually a physical component of the computer. Because these components are virtual and not physical, the virtual components may easily be shared with other computers. The virtualization software 114 generates a virtual framework within which the software application 116 is executed. The virtual framework provides the software application 116 with access to various virtual resources, such as network connections, file systems, mass storage devices, etc. The virtualization software 114 also is used to preserve the state of the application 116 in accordance with embodiments of the invention, as described below.

A network connection 120 couples the subsystems 102 and 104 via network ports 118 and 122. In addition to port 122, the subsystem 104 comprises a processor 124, a hard drive 126 comprising an OS 130 (e.g., WINDOWS®), and a storage (e.g., memory) 128 comprising virtualization software 132 and a software application 134. In some embodiments, the OS 112 and the OS 130 are of identical type. Likewise, in some embodiments, the virtualization software 114 and the virtualization software 132 are of identical type. In other embodiments, the OS 112 and 130 may be of different types and/or the virtualization software 114 and 132 may be of different types. Like the virtualization software 114, the virtualization software 132 is used to provide a virtual framework for execution of the application 134 and to preserve the state of the application 134 in accordance with embodiments of the invention described below. Like the processor 106, the processor 124 couples to one or more input devices 142 and/or one or more output devices 146.

While the processor 106 executes the software application 116, it may become necessary to perform a repair on the subsystem 102 that would normally require restarting or rebooting the subsystem 102. For example, the OS 112 may require a patch to repair a defect in the OS 112, and application of the patch to the OS 112 may require restarting the subsystem 102. Or, for instance, it may be necessary to recover the OS 112 from one or more critical problems (e.g., the application of faulty software, corruption of parts of a file system). Alternatively, an the OS may need updating/upgrading. In some cases, an application or a virtualization framework stored on the system may need patching or updating/upgrading. Such modifications would require restarting the subsystem 102. Restarting the subsystem 102 requires restarting the software application 116, which will cause the application to become unavailable, and may cause loss of state of the application 116. For example, an application 116 being executed may be performing various tasks and may have various settings (e.g., variable values) which would be lost if the subsystem 102 was restarted. Likewise, restarting the subsystem 102 causes undesirable application downtime.

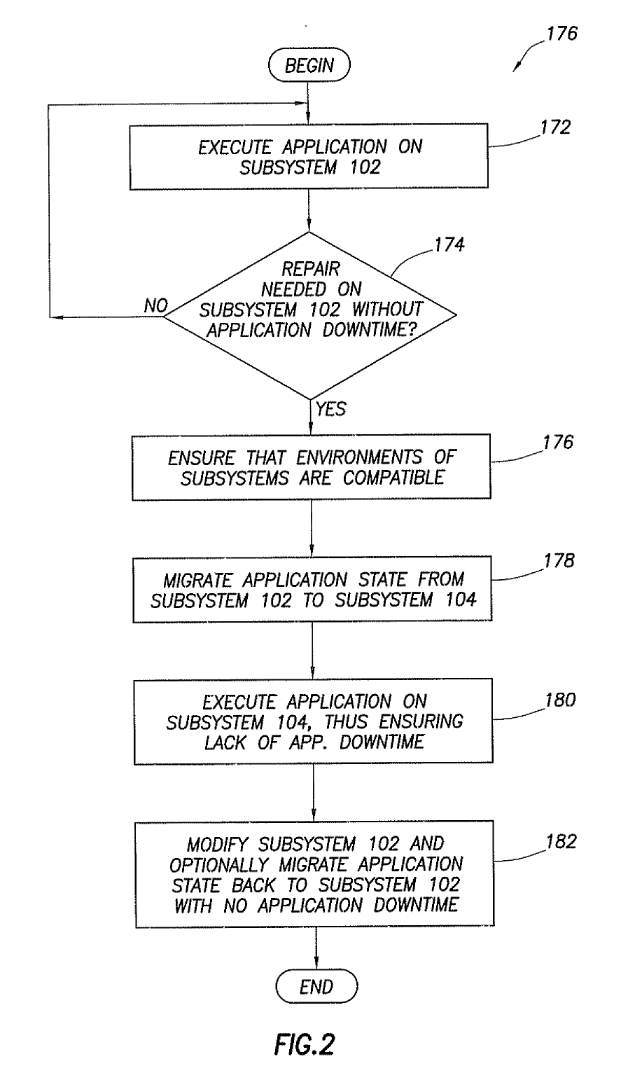

Accordingly, FIG. 2 provides a flowchart describing a method 170 by which application state is preserved, and application downtime reduced or eliminated, during a system modification such as an OS patching procedure or an OS recovery procedure. The method 170 is described in context of FIGS. 1 and 2. The method 170 begins by executing an application (e.g., application 116) on subsystem 102 (block 172). If it is determined that a modification (e.g., OS patch, upgrade or update, application upgrade or update, virtualization software upgrade or update) needs to be made to the subsystem 102 (block 174), the method 170 comprises ensuring that the environments (e.g., OSes, virtualization software, applications) of subsystems 102 and 104 are compatible such that each is capable of executing the application (block 176). The method 170 further comprises migrating the application state from the subsystem 102 to the subsystem 104 (block 178) and executing the application on subsystem 104, thereby ensuring a lack of application downtime (block 180). The method 170 comprises modifying (e.g., repairing) subsystem 102 and optionally migrating the application state back to subsystem 102, again with minimal or no application downtime (block 182).

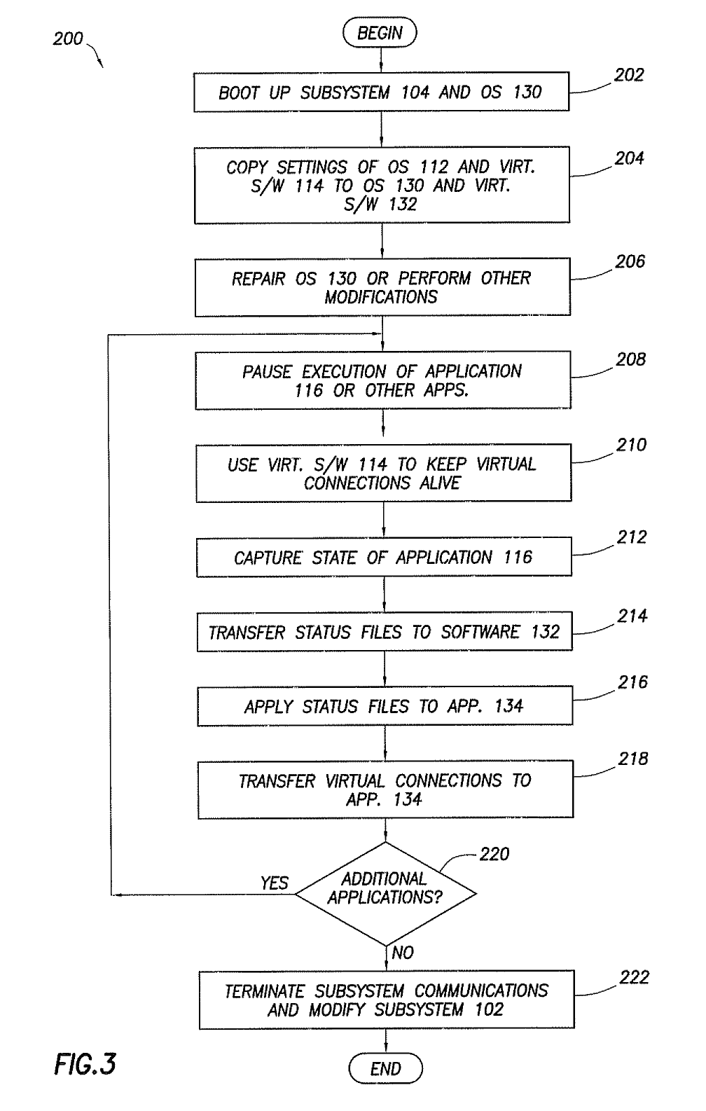

FIG. 3 provides a more detailed description of the method 170 of FIG. 2. Method 200 of FIG. 3 describes a process by which a repair or other type of modification is performed on the subsystem 102 by transferring some or all settings of subsystem 102 to subsystem 104, so that subsystem 104 has an environment compatible with that of subsystem 102. As such, the subsystem 104 inherits any defects associated with the subsystem 102. Stated in another way, because the settings of subsystem 102 are copied to subsystem 104, any modifications necessary to subsystem 102 also are necessary to subsystem 104. The method 200 comprises modifying the subsystem 104 as necessary, and then seamlessly transferring the application state from the subsystem 102 to subsystem 104. In this way, application downtime is reduced or eliminated. Once subsystem 104 assumes responsibility for executing the application, the subsystem 102 may be taken offline and repaired or modified as necessary. Referring now to FIG. 3, the method 200 begins by booting up the subsystem 104, including the OS 130 (block 202), and copying settings of the OS 112 and virtualization software 114 to the OS 130 and the virtualization software 132 (block 204). Settings are copied to the OS 130 and the virtualization software 132 to ensure that execution conditions for the application 134 on subsystem 104 are similar to the execution conditions for the application 116 on subsystem 102. Settings that may be transferred include process memory space, swap space, CPU registers, etc. which may store authentication credentials (e.g., Kerberos ticket), etc.

The method 200 continues by patching the OS 130 (block 206). The OS patch may, for instance, be downloaded from the Internet or may be provided by way of an input device 138 such as a data storage device (e.g., a compact disc or a flash drive). Alternatively, instead of patching the OS 130, the method 200 may include performing one or more other repairs or modifications to the subsystem 104. For example, if necessary, a recovery operation may be performed to recover the OS 130. In some embodiments, the recovered OS 130 is copied to, or installed on, the hard drive 126. The subsystem 104 then may be restarted if modifying the subsystem 104 or recovering/patching the OS 130 requires doing so.

After repairing the OS 130 or modifying other components of the subsystem 104, the state of the application 116 is transferred from the subsystem 102 to the subsystem 104 by transferring one or more status files associated with the application 116. Specifically, execution of the application 116 is paused (block 208). The virtualization software 114 is used to keep alive any virtual connections between virtual resources and the application 116 (block 210). Virtual connections that generally should be kept alive include any “stateful” network or local connections (i.e., connections which depend on the state of the system) with other components or users. The method 200 also comprises using the virtualization software 114 to capture the state of the application 116 (block 212). Capturing the state of the application 116 comprises collecting one or more status files which pertain to the state of the application 116.

After the state of the application 116 has been captured, the method 200 comprises using the virtualization software 114 and the virtualization software 132 to transfer the status files from the software 114 to the software 132 (block 214) and further comprises applying the status files to the application 134 using the virtualization software 132 (block 216). The method 200 further comprises transferring the virtual connections associated with the application 116 to the application 134 (block 218), so that the application 134 has access to the same or similar virtual resources as did the application 116. One or more steps of method 200 may be repeated for additional software applications stored on the subsystem 102 (block 220). After the states of the desired applications on subsystem 102 have been transferred to the subsystem 104, communications between the subsystems 102 and 104 may be terminated and the subsystem 102 may be repaired or otherwise modified (block 222). By migrating OS and application state information to the subsystem 104 in this way, application state is preserved, and application downtime is reduced or eliminated.

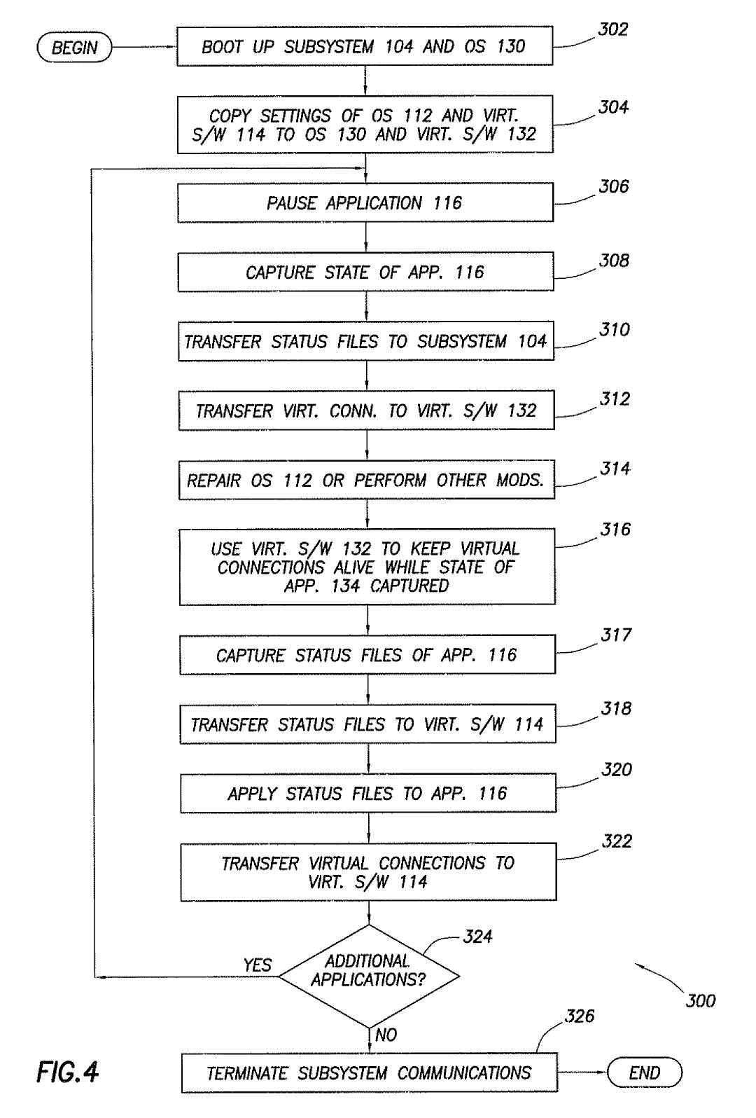

FIG. 3 represents one possible method by which the state of the application 116 is preserved, and application downtime reduced or eliminated, during modification of the subsystem 102. The scope of disclosure is not limited to this or any other specific method. For example, in the embodiment of FIG. 3, application state is preserved and application downtime is reduced or eliminated by adjusting the OS of the subsystem 104 to be similar to that of the subsystem 102, patching/recovering the OS of the subsystem 104 or otherwise modifying the subsystem 104, transferring the application state to the subsystem 104, and then using the subsystem 104 in place of the subsystem 102. In this way, the subsystem 102 is effectively replaced by the subsystem 104, the state of the application is preserved and application downtime is reduced or eliminated. However, in some embodiments, the subsystem 104 may be used as a temporary storage for the state (i.e., status files) of the application 116 while the subsystem 102 is modified. After the subsystem 102 is modified, the status files of the application 116 may be transferred back to the subsystem 102. Such embodiments are described in detail below in the context of a method 300 shown in FIG. 4.

Referring now to FIG. 4, method 300 begins by booting up subsystem 104 and OS 130 (block 302) and copying OS settings and virtualization software settings from the subsystem 102 to the subsystem 104 (block 304). The method 300 continues by pausing the application 116 (block 306) and using the virtualization software 114 to capture the state of the software application 116 (block 308). As described above, the virtualization software 114 captures the state of the application 116 by collecting status files associated with the application 116. The method 300 continues by transferring state information (i.e., status files) from the subsystem 102 to the subsystem 104 (block 310). The method 300 comprises transferring any virtual connections from the virtualization software 114 to the virtualization software 132 (block 312) so that the connections are kept “alive.”

The method 300 then comprises patching/recovering the OS 112 or performing other necessary modifications to the subsystem 102 (block 314). After the OS 112 is patched/recovered or the subsystem 102 is otherwise modified, the subsystem 102 may be restarted, if necessary. The method 300 further comprises using the virtualization software 132 to keep the virtual connections “alive” (block 316) while the virtualization software 132 collects status files associated with the application 134 (block 317). In at least some embodiments, these status files associated with the application 134 may be similar or identical to the status files previously transferred from the subsystem 102 to the subsystem 104.

The method 300 then comprises transferring the status files associated with the application 134 from the virtualization software 132 to the virtualization software 114 (block 318) and applying the status files to the application 116 (block 320). The method 300 also comprises transferring the virtual connections from the virtualization software 132 to the virtualization software 114 (block 322), so that the application 116 has access to the same virtual resources as it did before the OS 112 was patched/recovered or before other modifications were made to the subsystem 102. One or more of the steps of method 300 may be repeated for each application stored on the subsystem 102 requiring state preservation (block 324). In some embodiments, such repetition of the steps of method 300 may be performed in a parallel manner for each application requiring state preservation. In other embodiments, such repetition of the steps of method 300 may be performed in a serial manner for each application requiring state preservation. After the states of the desired applications have been preserved, the connection between the subsystems 102 and 104 may be terminated (block 326). In this way, the subsystem 102 is modified with virtually no application downtime and/or loss of application state.

The scope of disclosure is not limited to using two subsystems 102 and 104 as described above. In addition to using two distinct, electronic systems, a combination of an electronic system and a partition of a partitionable computer platform may be used. Likewise, a combination of an electronic system and a virtual machine may be used. Similarly, a combination of a virtual machine and a partition of a partitionable computer platform also may be used. The scope of disclosure also may include the use of two separate computer platforms which share a dynamic root disk (DRD) to migrate application state information and other data between the platforms. Further, the scope of disclosure is not limited to the use of any specific number of subsystems, computer platforms, virtual machines, etc. In some embodiments, any suitable number of such apparatuses may be used for additional capacity during application state migration.

In some embodiments, the above techniques may be integrated within an automated or manual analysis, performed by the subsystem 102, to detect problems with the subsystem 102 which require repair. For example, the subsystem 102 may run one or more diagnostic tests to determine if the subsystem 102 requires repair. If it is determined that the subsystem 102 requires repair, the subsystem 102 may automatically initiate the method 200 or the method 300. In other embodiments, a user of the subsystem 102 may manually run the diagnostic tests and may manually initiate one of the methods 200 or 300.

Such testing may be performed at any suitable time during the methods 200 or 300. In some embodiments, the testing may be performed before the application state is migrated, and whether the migration proceeds depends on the results of the testing. In other embodiments, the testing may be performed after the application state has been migrated, and the migration could be reversed based on the results of the testing (e.g., in the case of a system failure).

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A system, comprising:
a first subsystem adapted to provide a service by executing a first code stored on said first subsystem; and
a second subsystem, communicably coupled to the first subsystem, on which a second code associated with the first code is stored;
wherein the second subsystem produces modified code by applying status files associated with the first code to the second code;
wherein the second subsystem provides said service in lieu of the first subsystem by executing the modified code.

2. The system of claim 1, wherein:
the first subsystem is modified while the second subsystem provides said service in lieu of the first subsystem;
after the first subsystem is modified, status files associated with the second code are applied to the first code to produce modified code.

3. The system of claim 2, wherein said modification is selected from the group consisting of an operating system patch, an operating system upgrade and an operating system recovery.

4. The system of claim 2, wherein said modification comprises the modification of an application stored on the first subsystem.

5. The system of claim 2, wherein said modification comprises the modification of virtualization software stored on the first subsystem.

6. The system of claim 2, wherein said service is uninterrupted during said modification.

7. The system of claim 2, wherein the first subsystem provides said service in lieu of the second subsystem by executing said modified first code.

8. The system of claim 1, wherein the status files comprise files usable to maintain availability of the service.

9. The system of claim 1, wherein said subsystems are selected from the group consisting of computer platforms, partitions of computer platforms, virtual machines, servers, and personal computers.

10. The system of claim 1, wherein the first subsystem transfers said status files to the second subsystem in accordance with results of a diagnostic test executed to detect a necessary modification.

11. A method, comprising:
providing a service by executing a first software application;
capturing status files associated with said first software application;
applying said status files to a second software application to produce a modified application; and
using said modified application in lieu of the first software application to provide said service.

12. The method of claim 11 further comprising modifying an electronic device storing the first software application after the modified application is used to provide said service, wherein the electronic device is different from a second electronic device storing the second software application.

13. The method of claim 12, wherein, after modifying said electronic device, applying status files associated with the second software application to the first software application.

14. The method of claim 12 further comprising providing the another electronic device with virtual connections associated with the electronic device.

15. The method of claim 11, wherein said status files comprise files usable to maintain availability of said service.

16. A system, comprising:
means for providing a service by executing a first software application, said means for providing also usable to capture status files associated with said first software application; and
means for applying said status files to a second software application to produce a modified application;
wherein the means for applying provides said service using the modified application in lieu of the first application.

17. The system of claim 16, wherein the status files comprise files used to maintain availability of said service.

18. The system of claim 16, wherein:
the means for providing is modified while the means for applying provides said service;
after the means for providing is modified, the means for providing applies status files associated with the modified application to the first software application.

19. The system of claim 18, wherein said modification is selected from the group consisting of an operating system patch, an operating system upgrade, an operating system recovery, an application modification and a virtualization software modification.

20. The system of claim 18, wherein said service is uninterrupted during said modification.
